(19) United States
(12) Patent Application Publication
(10) Pub. No.: US 2002/0162895 A1
(43) Pub. Date: Nov. 7, 2002

(54) Pre-paid telephone card for internet access

(76) Inventor: Aristides Franca Neto, Belo Horizonte (BR)

Correspondence Address: DICKINSON WRIGHT PLLC, 1901 L Street, N.W., Suite 800, Washington, DC, 20036, US

(21) Appl. No.: 10/091,280

(22) Filed: Mar. 6, 2002

(30) Foreign Application Priority Data
May 3, 2001 (BR) PI0102515-5

(51) Int. Cl. G06K 19/06

(52) U.S. Cl. 235/494

(57) ABSTRACT

The present invention relates to a prepaid internet card having a telephone number and password or PIN which enables a user to connect to a global computer network via a designated internet service provider. Each password or PIN is assigned to an account with means for keeping track of the time left on the card. A protective cover, such as scratch-off paint, can be provided to conceal the passwork or PIN so that unauthorized users will not be able to obtain access to the connection and account.

### FIELD OF THE INVENTION

The present invention relates to a prepaid internet card similar in size and format to a business card, credit card or phone card.

### BACKGROUND OF THE INVENTION

Prepaid telephone cards are available which have a toll-free telephone number and PIN (personal identification number). A predetermined amount of time is preferably provided on each card which can be used to make long distance telephone calls. Preferably, the user dials the number from any telephone, and, by following the instructions on the card, i.e., entering the PIN, can make long distance telephone calls on a pre-paid basis. The system that operates and makes the connection keeps track of the time left on the card, such that the user is notified when time expires.

Most internet service providers offer unlimited usage for a fixed monthly fee, but some still charge based on the amount of time spent online, i.e., a per-minute basis. In most cases, the user is required to become registered by the internet service provider so that an account can be opened in the user's name and charges to the account can be billed and paid. This may require, for example, the user to provide a credit card number or other payment means to enable the service provider to collect the fees for the service.

### SUMMARY OF THE INVENTION

The prepaid internet card of the present invention is preferably similar in size and shape to a business card, credit card or phone card, but can be any size and shape. One aspect of the invention is that it preferably has thereon information pertaining to how the user can connect to a global computer network, such as the “world wide web,” via a designated internet service provider working in connection with the issuance of the card.

The card preferably contains the following:

1. Identification, such as name and logo, of the internet service provider.

2. The website of the internet service provider and/or other connective identification such as an email address.

3. The telephone number of the internet service provider that can be entered by the user to connect his or her computer to the global computer network via the internet service provider. This is preferably a toll free number assigned by the system which the user can enter into a computer terminal, wherein the computer can be instructed to be connected to the service provider's server, via the telephone line to which it is connected. This can be done by any computer that has installed thereon a software program that enables the computer to transmit the telephone number and connect to the service provider's server.

4. A password or PIN, such as an alpha-numeric code, which identifies the user when the user attempts to connect to the internet service provider. This is a code that is pre-assigned to a particular card, wherein when a user buys the card and enters the code into the computer, the service provider's system recognizes the code and allows internet access to the user depending on how much time is left on the account assigned to that code. The system preferably keeps track of the amount of time left on the account during the time that the computer is connected, and notifies the user when time is about to expire. The system preferably terminates the connection when time expires.

5. The value of the card, i.e., the amount of time that is pre-paid on the card, in the account assigned to the particular code. The card can come with any predetermined amount or duration, and the price of the card can be based on the amount of time on the card.

6. A protective cover, such as scratch-off paint, which conceals the password or PIN so that unauthorized users are not able to access the password or PIN needed to connect to the internet and account. The buyer/user of the card can reveal the code simply by scratching off the paint, but if the cover is damaged or otherwise removed without authorization, the buyer will know that an unauthorized individual may have obtained access to the password or PIN on the card. The user can then seek to have the card replaced, or otherwise report it to the internet service provider.

### BRIEF DESCRIPTION OF THE DRAWING

FIG. 1 shows a front view of one embodiment of the present card.

### DETAILED DESCRIPTION OF THE INVENTION

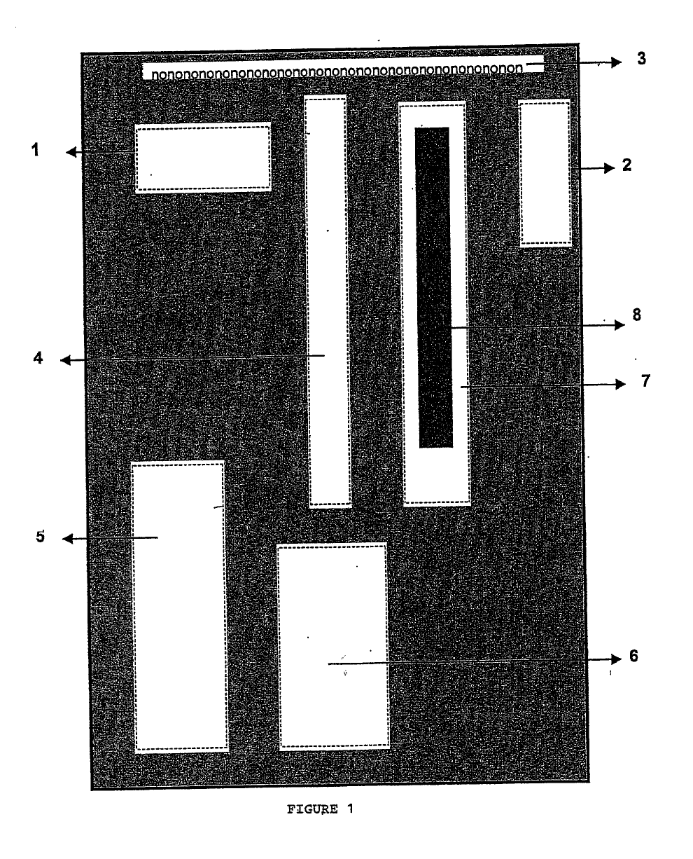

As seen in the aforementioned FIG. 1, the card is preferably substantially rectangular, with dimensions similar to a business card, credit card or phone card, although any size and shape can be used. The main body of the card preferably consists of spaces for printing or applying information (the locations of which are provided solely for exemplary purposes and are by no means intended to be limiting), including the following:

1. Identification, such as name and logo, of the designated internet service provider company, shown as (1).

2. Additional identification, such as name and logo, of any affiliated company, i.e., a telephone company, shown as (2).

3. The website and/or other connective identification of the internet service provider, such as an email address, shown as (3).

4. The telephone number of the internet connection, which is preferably a toll-free number, shown as (4). This is the telephone number used by the user to connect to the global computer network via the internet service provider. This number is preferably entered into a computer terminal, wherein the computer's software enables the computer to be connected to the service provider's server via the telephone line. This can be done by any computer that has software installed that enables the computer to transmit the telephone number and connect to the service provider's server.

5. Additional information or advertisements, shown as (5).

6. The value of the card, shown as (6). This is the amount of time that is prepaid on the card assigned to the account that corresponds to the code. The card can come with any amount or duration, such as 30 minutes, 60 minutes, 350 minutes, etc., on the account. The price of the card preferably corresponds with the amount of time on the card.

7. A password or PIN, such as an alpha-numeric code, shown as (7), which identifies the user when the user attempts to connect his or her computer to the internet service provider's server. This is a code that is pre-assigned to a particular card, wherein when a user buys the card and enters the code at the appropriate time, the internet service provider system recognizes the code and allows internet access to the user depending on how much time is left in the account assigned to that code. The system preferably keeps track of the amount of time left on the account, and notifies the user when time is about to expire. The system preferably terminates the connection when time expires.

8. A protective cover, such as scratch-off paint, shown as (8), which conceals the password or PIN on the card is preferably provided so that unauthorized users are not able to access the password or PIN needed to connect to the internet service provider. The buyer/user of the card can reveal the code to make the connection by scratching off the paint, but if the cover is damaged or otherwise removed, the buyer will know that an unauthorized individual could have obtained the password or PIN on the card. The user can then seek to have the card replaced, or otherwise report it to the internet service provider. The protective cover can also be adapted to cover other information on the card, as necessary, such as the toll-free telephone number (4).

The card is intended to enable any user that buys the card, and that has a computer, such as a desk-top terminal, laptop, PDA, etc., with a modem connected to a telephone line, to access the internet. The computer must have the appropriate software program installed that will enable the telephone number to be entered and transmitted to the designated internet service provider to make the connection. Such a program is often provided with the purchase of a computer, but can also be provided in any conventional manner, i.e., downloading, cd-roms, etc.

A different code is preferably printed on each card, and each code is preferably assigned to a different account in the system, with a predetermined amount of time allocated to each account, such that with every card that is purchased, and used, a user will be entitled to a fixed amount of time in the account. As the user uses the system, a time keeping means is preferably provided by the system to keep track of the amount of time left on each account, such that the system can notify the user when time in the account is about to expire. It preferably terminates the internet connection when time does expire. Preferably, the system enables the user to add time to the card, i.e., by adding money to the account, which can be done through entries made to the system via a credit card or the like.

The card preferably enables a user to become registered to connect to the internet without having to go through the steps of calling and filling out forms to become a registered member. Since the card is pre-paid, no further information regarding the user and his or her financial ability to pay is needed. Also, since each card is assigned a different code, there is no need to identify the user by name, and, since each code it, accesses a different account, each account can be metered independently. Lastly, the toll-free telephone number will enable any user from any location to become connected without any further telephone charges.

The card can be used for advertising and has commercial value in that sense. That is, advertisements can be printed on the card, such that when a user uses the card, he or she will see the advertising. Additional information can be provided on the back of the card. Not all of the information on the card discussed above are required. Only the telephone number and code are essential. The value of the card and name of the provider are preferred.

The card can be made of any conventional material, such as paper, plastic, recyclable materials, cardboard, etc. The printing or application of information can be by any conventional means, and the scratch-off paint can be applied in any conventional manner. A peel-off strip can be used in place of the scratch-off paint if desired, although it may be more difficult to tell if the strip is removed and replaced. Other information, such as a bar code, or advertising or decoration, can also be printed on the card.

In the claims:

1. A card with information thereon, comprising:
a first portion having a telephone number thereon capable of being used to connect a computer device to an internet service provider via a telephone connection and a global computer network;
a second portion having a code thereon, wherein said code can be used as a password for enabling said computer device to be connected to said global computer network, and have access to an account associated with said code; and
a third portion indicating the amount of time that has been allocated to said account.

2. The card of claim 1, wherein said card has a fourth portion with information regarding the internet service provider, and a fifth portion with connective identification.

3. The card of claim 2, wherein said connective identification is a website or email address of the internet service provider.

4. The card of claim 1, wherein a removable protective cover is provided to conceal the information on said second portion.

5. The card of claim 4, wherein said protective cover is comprised of scratch-off paint or other scratch-off material.

6. The card of claim 4, wherein said protective cover is comprised of a peel-off strip.

7. The card of claim 1, wherein one or more removable protective covers are provided to conceal the information on said first and second portions.

8. The card of claim 1, wherein said telephone number is a toll-free number.

9. The card of claim 1, wherein said code comprises alpha-numeric symbols.

10. The card of claim 1, wherein said code is assigned to an account, wherein the time allocated to the account determines how long the computer can remain connected to said global computer network.

11. A card comprising:
a first portion having a telephone number thereon capable of being used to connect a computer device to an internet service provider via a telephone connection and a global computer network;
a second portion having a code thereon, wherein said code can be used as a password for enabling said computer device to be connected to said global computer network, and have access to an account associated with said code; and
wherein one or more removable protective covers are provided to conceal the information on said first and/or second portions.

12. The card of claim 11, wherein said one or more protective covers are comprised of scratch-off paint or other scratch-off material.

13. The card of claim 11, wherein said one or more protective covers are comprised of a peel-off strip.

14. The card of claim 11, wherein a predetermined amount of time has been allocated to said account, and wherein the time allocated to said account determines how long the computer can remain connected to said global computer network.

15. A method of providing a card to connect to a global computer network, comprising:
providing a card with a telephone number and code thereon;
enabling a computer to be used to enter the telephone number and code to connect to said global computer network and access an account associated with said code;
allocating a predetermined amount of time on said account; and
enabling said computer to be connected to said global computer network for said predetermined amount of time, wherein said connection is terminated at the expiration of said amount of time.

16. The method of claim 15, wherein multiple cards are provided, and a different code is provided on each card, and each code is assigned to a different account.

17. The method of claim 16, wherein a first portion of said multiple cards is provided with codes that are assigned to accounts having a first predetermined amount of time allocated thereto, and a second portion of said multiple cards is provided with codes that are assigned to accounts having a second predetermined amount of time allocated thereto.

18. The method of claim 15, wherein a notification that the amount of time is about to expire is given.

19. The method of claim 15, wherein said predetermined amount of time allocated to said account can be adjusted.
